(19) United States
(12) Patent Application Publication
(10) Pub. No.: US 2017/0228143 A1
(43) Pub. Date: Aug. 10, 2017

(54) IMPROVEMENTS RELATED TO USER INTERFACES

(71) Applicant: Jaguar Land Rover Limited, Coventry (GB)

(72) Inventor: Stefanos Dervitsiotis, Coventry (GB)

(21) Appl. No.: 15/503,169

(22) PCT Filed: Aug. 19, 2015
(86) PCT No.: PCT/EP2015/069019

§ 371 Date: Feb. 10, 2017

(30) Foreign Application Priority Data
Aug. 20, 2014 (GB) 1414781.3

(51) Int. Cl. G06F 3/0484; G06F 17/22; G06F 3/0482

(52) U.S. Cl. CPC G06F 3/04845; G06F 3/0482; G06F 17/2247; G06F 2203/04806; G06F 3/04883

(57) ABSTRACT

A controller for a display device, the controller comprising: an input for receiving user commands; a processor arranged to generate a display signal in dependence on the received user commands; and an output for sending the display signal to the display device; wherein the display signal is arranged to display on the display device: a content layer; and a user interface element overlaid on the content layer and moveable relative to the content layer and configured to transition between an unexpended and expanded state in dependence on at least one of the received user commands; wherein the user interface element is only moveable relative to the content layer when in the unexpended state.

### TECHNICAL FIELD

The present disclosure is concerned with improvements related to user interfaces and particularly, but not exclusively, to a user interface suitable for small displays. Aspects of the invention relate to a controller, to a device, to a vehicle and to a method.

### BACKGROUND

Mobile devices such as mobile phones, satellite navigation systems, in-vehicle entertainment systems and smart watches typically have small display screens, for example with a diagonal length of less than 10 inches (25.4 centimetres). This results in a limited area to display content on small displays, and leads to a compromise between how the space on the display is divided between content and user interface elements.

The present invention has been devised to mitigate or overcome at least some of the above-mentioned problems.

### SUMMARY OF THE INVENTION

According to one aspect of the present invention there is provided a controller for a display device, the controller comprising: an input for receiving user commands; a processor arranged to generate a display signal in dependence on the received user commands; and an output for sending the display signal to the display device; wherein the display signal is arranged to display on the display device: a content layer; and a user interface element overlaid on the content layer and moveable relative to the content layer and configured to transition between an unexpanded and expanded state in dependence on at least one of the received user commands, wherein the user interface element is only moveable relative to the content layer when in the unexpanded state.

The user interface element may be moveable relative to the content layer to ensure that the user interface element does not block the content layer from being displayed by the display device.

The user interface element may be moveable from an initial position to a further position in response to a first user command.

The user interface element may be configured to transition between the unexpanded and expanded state, at said further position, in response to said first user command.

The user interface element may be configured to transition between the unexpanded and expanded state, at said further position, in response to a second user command.

The user interface element may be moveable from the further position to the initial position and configured to transition between the unexpanded and expanded state, at said initial position, in response to a second user command.

The user interface element may be configured to return to the unexpanded state, at said initial position, in response to a further user command.

Additionally, the processor may comprise and/or may be configured to run a web browser. The web browser may be configured to support webpage scripts and any embedded media or applications such as HyperText Markup Language (HTML), HTML5,Cascading Style Sheets, JavaScript, Adobe Flash, Microsoft Silverlight.

The content layer may comprise webpage.

Additionally, the user interface element may comprise a menu, and the menu may have at least one button.

The input may comprise one or more of a plurality of buttons and a touchscreen.

The invention extends to a vehicle, a mobile device or a display device comprising the controller. In the case where the invention to a mobile device, the mobile device may be one of: a mobile phone, a satellite navigation system, or a watch.

According to another aspect of the present invention there is provided a method of controlling a display device, the method comprising: receiving user commands; generating a display signal in dependence on the received user commands; and sending the display signal to the display device; wherein the display signal is arranged to display on the display device: a content layer; and a user interface element overlaid on the content layer and moveable relative to the content layer and configured to transition between an unexpanded and expanded state in dependence on at least one of the received user commands, wherein the user interface element is only moveable relative to the content layer when in the unexpanded state.

The method may comprise moving the user interface element from an initial position to a further position in response to a first user command.

The method may comprise transitioning the user interface element between the unexpanded and expanded state, at said further position, in response to said first user command.

The method may comprise transitioning the user interface element between the unexpanded and expanded state, at said further position, in response to a second user command.

The method may comprise moving the user interface element from the further position to the initial position and transitioning the user interface element between the unexpanded and expanded state, at said initial position, in response to a second user command.

Advantageously, the first and second user commands may be input via a single user gesture wherein the single user gesture could be any one of: a press and release of a button, a drag and release of a touch screen display or a touch and release of a touch screen display.

The method may comprise returning the user interface element to the unexpanded state, at said initial position, in response to a further user command.

Additionally, a computer program product may comprise computer readable code for controlling a computing device to carry out the method.

For purposes of this disclosure, it is to be understood that the controller described herein can comprise a control unit or computational device having one or more electronic processors.

A vehicle and/or a system thereof may comprise a single control unit or electronic controller or alternatively different functions of the controller may be embodied in, or hosted in, different control units or controllers.

As used herein, the term “control unit” will be understood to include both a single control unit or controller and a plurality of control units or controllers collectively operating to provide the required control functionality.

A set of instructions could be provided which, when executed, cause said controller(s) or control unit(s) to implement the control techniques described herein (including the method(s) described below). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present invention is not intended to be limited to any particular arrangement. In any event, the set of instructions described above may be embedded in a computer-readable storage medium (e.g., a non-transitory storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM ad EEPROM); flash memory; or electrical or other types of medium for storing such information/instructions.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic block diagram of a system configured to control a user interface according to an embodiment of the present invention;

FIG. 2 is a wireframe diagram of a user interface showing an expandable menu according an embodiment of the present invention;

FIG. 3 is a wireframe diagram of a user interface showing a menu according to an embodiment of the present invention;

FIG. 4 is a wireframe diagram of a user interface showing a favourites menu according to an embodiment of the present invention; and

FIG. 5 is a wireframe diagram of a user interface showing a moveable menu according to an embodiment of the present invention.

### DETAILED DESCRIPTION

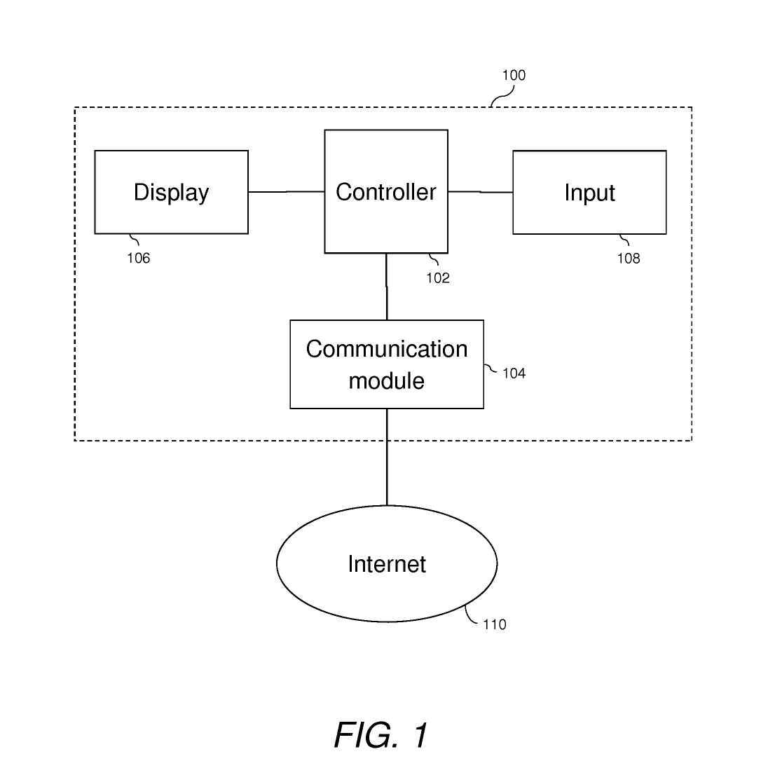

FIG. 1 shows a system 100 configured to control a user interface. The system 100 comprises a controller 102, a communication module 104, a display 106 and an input 108.

The communication module 104, the display 106 and the input 108 are each operatively connected to the controller 102.

The communication module 104 is configured to communicate data to and from the Internet 110 wirelessly. For example, using Wi-Fi, Bluetooth, GPRS, 3G or LTE protocols as are known in the art.

The display 106 and the input 108 enable the user to interact with the system 100. The input 108 may comprise a directional pad, a keyboard and/or a microphone configured to receive voice commands. The display 106 provides visual feedback to the user. In other embodiments, the input 108 is integral to the display 106, for example, in a touchscreen monitor.

The controller 102 is configured to generate graphics that are displayed on the display 106. The controller 102 processes content received from the Internet 110 via the communication module 104 to be displayed to a user. The content may be a webpage and the controller 102 uses a browser to interpret the webpage scripts and any embedded media or applications and generate a user interface, providing icons for the user to navigate the content. The user interacts with the user interface via the input 108. In other embodiments, the controller 102 may be configured with an operating system and the content may be applications running on the operating system.

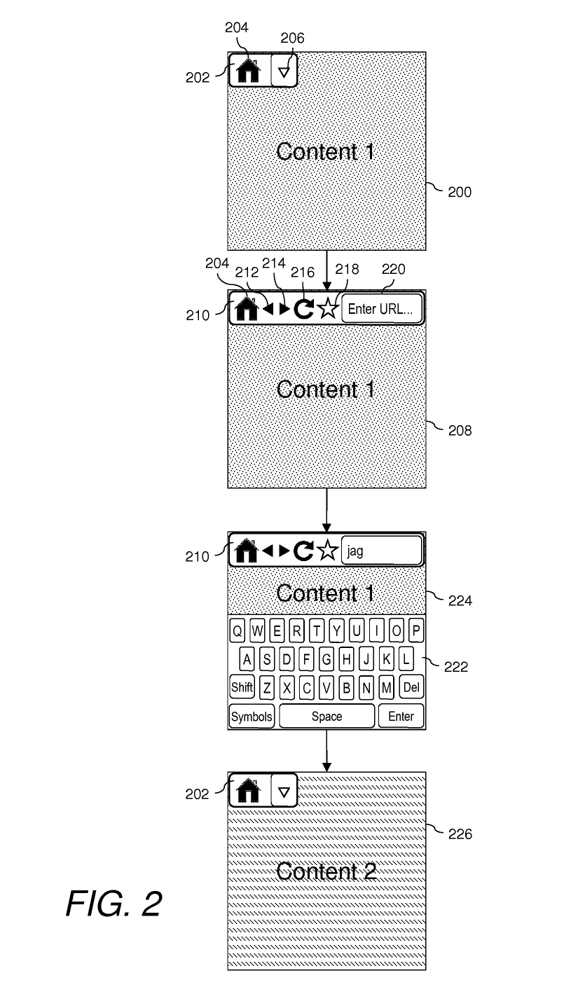

FIG. 2 shows the display 106 showing a website, Content 1, in View 200. The controller 102 generates a menu 202 with a home button 204 and a menu expansion button 206. If the user clicks the home button 204, a predetermined website (a “home page”) is requested by the controller 102 from the Internet 110 via the communications module 104.

When the user clicks on the menu expansion button 206, the menu 202 expands as shown in View 208. The expanded menu 210 provides additional user interface elements, although less of Content 1 is viewable. The user interface elements generated by the controller 102 for display comprise a back navigation button 212, a forward navigation button 214, a reload button 216, a favourites button 218 and a uniform resource location (URL) entry bar 220.

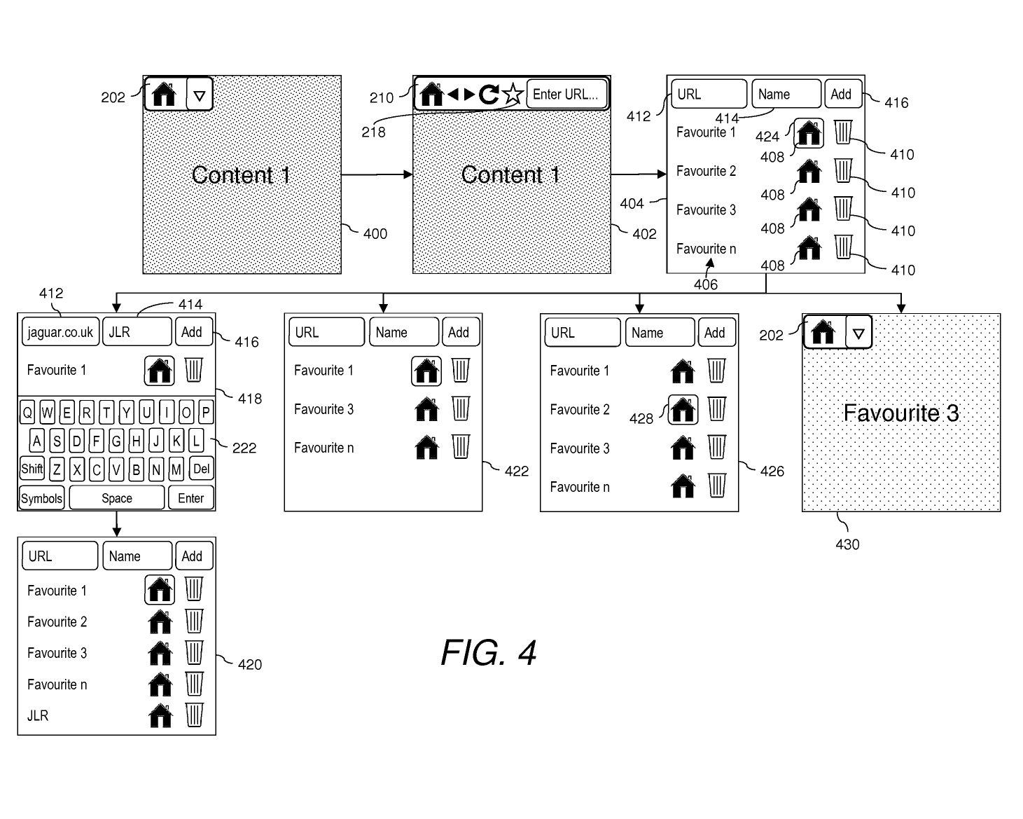

The back navigation button 212 and the forward navigation button 214 enable the user to navigate between websites that the user has historically visited. The reload button 216 sends a command to the controller 102 to reload the current website. The favourites button 218 (represented by the outline of a five point star in this figure) accesses a favourites sub-menu for storing and managing website addresses and is discussed in more detail later with reference to FIG. 4. The URL entry bar 220 can be used to navigate to other websites by typing in the address of the website.

If the user wishes to enter a URL, clicking the URL entry bar 220 brings up an onscreen keyboard 222 as shown in View 224. The user controls the onscreen keyboard 222 using the input 108. Once the user successfully enters the desired webpage address, the controller 102 obtains the webpage from the Internet 110 via the communication module 104. Accordingly, as shown in View 226, a website, Content 2, is displayed. At this point, the expanded menu reverts to the collapsed menu 202 to allow more of Content 2 to be shown.

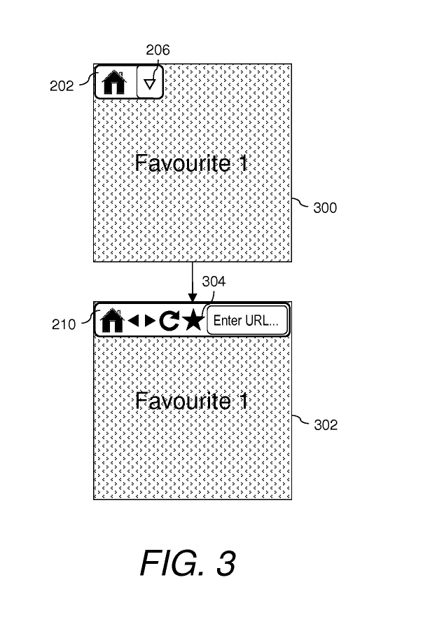

FIG. 3 shows the display 106 showing a website, Favourite 1, in View 300. The website address of Favourite 1 has previously been stored by the user in the favourites sub-menu. When the user clicks on the menu expansion button 206, the expanded menu 210 is generated by the controller 102 as shown in View 302. In this case, the favourites button 304 is represented by a solid five point star to represent that the website address is already stored.

FIG. 4 shows the display 106 showing a website, Content 1, in View 400. The menu is expanded into the expanded menu 210 as shown in View 402 to provide the user with access to the additional user interface elements. If the user clicks on the favourites button 218, the favourites sub-menu is shown on the screen as in View 404.

The favourites sub-menu comprises a list of stored website addresses 406, each of which has a set home button 408 and a delete entry button 410. The favourites sub-menu further comprises user interface elements that allow the user to manually define a website address to add to the stored list, namely a URL entry bar 412, a name entry bar 414 and an add button 416.

In order to store a new website into the favourites list, the user enters a URL in the URL entry bar 412 and a name in the name entry bar 414 using the keyboard 222 as shown in

View 418. Following this, the user clicks the add button 416 which instructs the controller 102 to store the website address. The updated favourites sub-menu is shown in View 420. In other embodiments, when the expanded menu 210 is shown for example in View 402 or View 208, the user clicks and holds the favourites button 218 for a predetermined length of time to store the current website address (in this case, Content 1) into the favourites sub-menu.

From the favourites sub-menu in View 404, the user may also remove a stored website address from the list. The user clicks the delete entry button 410 corresponding to the website they wish to remove and this instructs the controller 102 to delete the website. The updated favourites sub-menu is shown in View 422.

In the favourites sub-menu in View 404, Favourite 1 is currently set to be the home page, the predetermined website loaded when the user clicks the home button 204. This is signified by the outline 424 around the set home button 408 for Favourite 1. The user may set any of the website addresses in the favourites list as the home page. In order to set a stored website address as the new home page, the user clicks on the set home button 408 corresponding to the website they wish to set as the new home page, for example Favourite 2. The updated favourites sub-menu is shown in View 426, with an outline 428 around Favourite 2 signifying that it is the current home page.

In other embodiments when either the collapsed menu 202 or the expanded menu 210 is shown for example in View 402 or View 200, the user clicks and holds the home button 204 for a predetermined length of time to store the current website address (in this case, Content 1) as the home page.

From the favourites sub-menu in View 404, the user may navigate to a stored website by clicking on the name of the website, for example Favourite 3. Accordingly, as shown in View 430, a website, Favourite 3, is displayed. At this point, the expanded menu reverts to the collapsed menu 202 to allow more Favourite 3 to be shown.

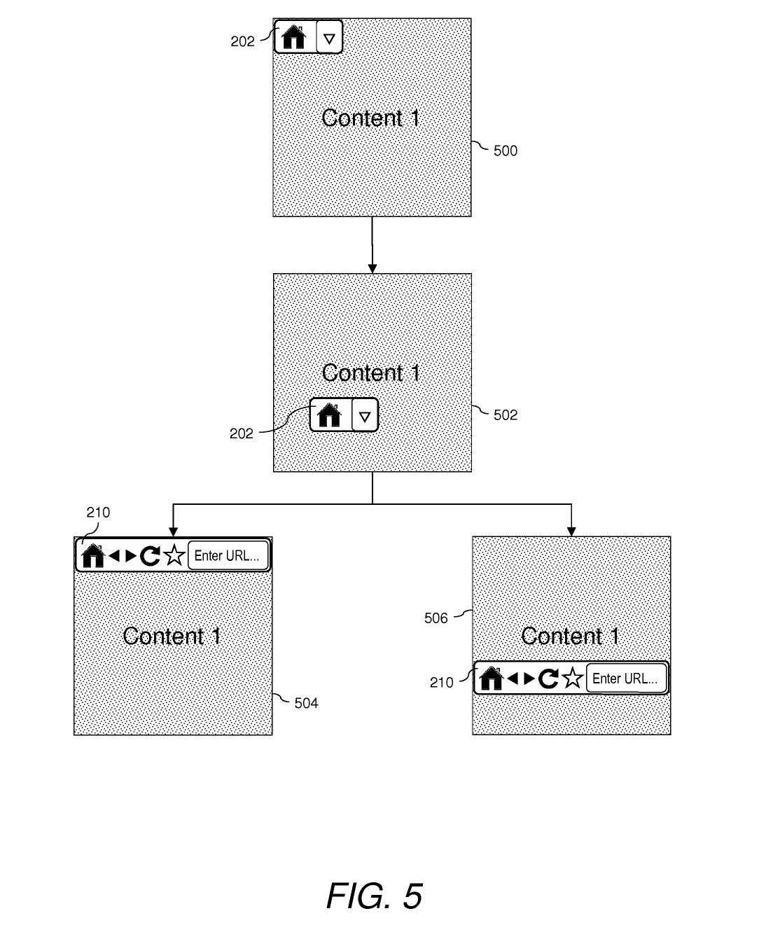

FIG. 5 shows the display 106 showing a website, Content 1, in View 500. If the menu 202 is obscuring a portion of Content 1, the user can move the menu 202 around the screen using the input 108 to relocate the menu 202 relative to the content as shown in View 502. When the user clicks to expand the menu 202, the expanded menu 210 returns to position at the top of the screen as shown in View 504. In other embodiments, the menu expands in situ as shown in View 506. Expanding the menu in situ may be advantageous to reduce animations generated by the controller 102 compared to returning the expanded menu 210 to the top of the screen. This may benefit users who may find the movement animations nausea-inducing. The expanded menu 210 can also be moved around the screen relative to the content.

Many modifications may be made to the above examples without departing from the scope of the present invention as defined in the accompanying claims.

Further aspects of the present invention are set out in the following numbered paragraphs:
1. A controller for a display device, the controller comprising:
an input for receiving user commands;
a processor arranged to generate a display signal in dependence on the received user commands; and
an output for sending the display signal to the display device;
wherein the display signal is arranged to display on the display device:
a content layer; and
a user interface element overlaid on the content layer and moveable relative to the content layer and configured to transition between an unexpanded and expanded state in dependence on at least one of the received user commands.
2. The controller of Paragraph 1 wherein the processor comprises a web browser.
3. The controller of Paragraph 2 wherein the web browser is configured to support HTML5.
4. The controller of Paragraph 1 wherein the content layer comprises a webpage.
5. The controller of Paragraph 1 wherein the user interface element comprises a menu.

6. The controller of Paragraph 5 wherein the menu comprises at least one button.
7. The controller of Paragraphs 1 wherein the input comprises one of: a plurality of buttons or a touchscreen.
8. A vehicle comprising the controller of Paragraph 1.
9. A mobile device comprising the controller of Paragraph 1.
10. The mobile device of Paragraph 9, wherein the mobile device is one of: a mobile phone, a satellite navigation system, or a watch.
11. A display device arranged to receive display signals from the controller of Paragraph 1.
12. A method of controlling a display device, the method comprising:
receiving user commands;
generating a display signal in dependence on the received user commands; and
sending the display signal to the display device;
wherein the display signal is arranged to display on the display device:
a content layer; and
a user interface element overlaid on the content layer and moveable relative to the content layer and configured to transition between an unexpanded and expanded state in dependence on at least one of the received user commands.
13. A non-transitory computer readable medium storing a program for controlling a computing device to carry out the method of Paragraph 12.

1. A controller for a display device, the controller comprising:
an input configured to receive user commands;
a processor configured to generate a display signal in dependence on the received user commands; and
an output configured to send the display signal to the display device;
wherein the display signal is configured to display on the display device:
a content layer; and
a user interface element overlaid on the content layer and moveable relative to the content layer and configured to transition between an unexpanded and expanded state in dependence on at least one of the received user commands;
wherein the user interface element is only moveable relative to the content layer when in the unexpanded state, and
wherein when in the expanded state the user interface element comprises a plurality of buttons and a uniform resource location entry bar,

2. The controller of claim 1, wherein the user interface element is moveable from an initial position to a further position in response to a first user command.

3. The controller of claim 2, wherein the user interface element is configured to transition between the unexpanded and expanded state, at said further position, in response to said first user command.

4. The controller of claim 2, wherein the user interface element is configured to transition between the unexpanded and expanded state, at said further position, in response to a second user command.

5. The controller of claim 2, wherein the user interface element is moveable from the further position to the initial position and configured to transition between the unexpanded and expanded state, at said initial position, in response to a second user command,

6. The controller of claim 2, wherein the user interface element is configured to return to the unexpanded state, at said initial position, in response to a further user command.

7. The controller of claim 1, wherein the processor is configured to run a web browser, wherein the web browser is configured to support a scripting language and/or HTML5.

8. (canceled)

9. The controller of claim 1, wherein the content layer comprises a webpage,

10. The controller of claim 1, wherein the user interface element comprises a menu, and wherein the menu comprises at least one button.

11. (canceled)

12. The controller of claim 1, wherein the input comprises one of: a plurality of buttons or a touchscreen.

13. A vehicle or a mobile device comprising the controller of claim 1.

14. (canceled)

15. The mobile device of claim 13, wherein the mobile device is one of: a mobile phone, a satellite navigation system, or a watch.

16. A display device arranged to receive display signals from the controller of claim 1.

17. A method of controlling a display device, the method comprising:
receiving user commands;
generating a display signal in dependence on the received user commands; and
sending the display signal to the display device;
wherein the display signal is arranged to display on the display device:
a content layer; and
a user interface element overlaid on the content layer and moveable relative to the content layer and configured to transition between an unexpanded and expanded state in dependence on at least one of the received user commands, wherein the user interface element is only moveable relative to the content layer when in the unexpanded state and wherein when in the expanded state the user interface element comprises a plurality of buttons and a uniform resource location entry bar.

18. The method of claim 17, further comprising moving the user interface element from an initial position to a further position in response to a first user command.

19. The method of claim 18, further comprising transitioning the user interface element between the unexpanded and expanded state, at said further position, in response to said first user command.

20. The method of claim 18, further comprising transitioning the user interface element between the unexpanded and expanded state, at said further position, in response to a second user command.

21. The method of claim 18, further comprising moving the user interface element from the further position to the initial position and transitioning the user interface element between the unexpanded and expanded state, at said initial position, in response to a second user command.

22. The method of claim 18, further comprising returning the user interface element to the unexpanded state, at said initial position, in response to a further user command.

23. A computer program product comprising a non-transitory computer readable storage medium having instructions that, when executed on a processor, cause the processor to carry out the method of claim 17.

24. (canceled)
